(19) United States
(12) Patent Application Publication
(10) Pub. No.: US 2021/0370203 A1
(43) Pub. Date: Dec. 2, 2021

(54) SANITARY DISC STRAINER

(71) Applicant: Timothy David Reuter, Mount Horeb, WI (US)

(72) Inventor: Timothy David Reuter, Mount Horeb, WI (US)

(21) Appl. No.: 17/337,184

(22) Filed: Jun. 2, 2021

Related U.S. Application Data
(60) Provisional application No. 63/033,506, filed on Jun. 2, 2020.

(51) Int. Cl. B01D 29/39

(52) U.S. Cl. CPC B01D 29/395; B01D 29/0068

(57) ABSTRACT

A device and method for removing debris from a process fluid are described herein. Specifically, a sanitary disc strainer includes a strainer body, a moveable guide rod assembly, moveable within the strainer body, a plurality of grooved discs stacked on the moveable guide rod assembly, and an actuator for moving the moveable guide rod assembly to compress and decompress the plurality of grooved discs.

### CROSS-REFERENCE TO RELATED APPLICATIONS

This application claims priority to and the benefit of U.S. Provisional Application No. 63/033,506, entitled “Sanitary Disc Strainer”, filed on Jun. 2, 2020, which is incorporated by reference herein in its entirety for all purposes.

### BACKGROUND

The present disclosure relates to the field of sanitary strainers. The present disclosure more specifically relates to the field of sanitary strainers for use in food, beverage, cosmetic, and pharmaceutical industries.

Sanitary strainers are used in the food, beverage, cosmetics and pharmaceutical industries to remove physical contaminants from process streams to protect other processing equipment such as homogenizers, meters, spray nozzles, needle valves, heat exchangers, and pumps. Sanitary strainers are used to promote sanitation, optimize manufacturing and particle separations, and are cost effective for improved product quality and ensuring uniformity. Further, cleaning solutions recirculated through processing equipment commonly employ strainers to prevent the recirculation of physical contaminants into the processing equipment.

Examples of types of products the sanitary strainers are used for include, for example: ice cream, jellies, bakeries, cosmetics, icing, mustard, toothpaste, ketchup, cheese, mayonnaise, butter, yogurt, salad dressing, milk, soups, chocolate, and cleaning in place solutions. While specific examples are provided one of skill in the art will appreciate that sanitary strainers may apply to other products and industries not expressly mentioned.

There are multiple types of strainers used for straining products. For example, for coarse straining, a perforated strainer element is usually perforated with 3/32″, ⅛″ and ¼″ diameter holes. For finer straining, a perforated strainer element with wire mesh overlay ranging from 0.075″ to 0.003″ opening may be used. An example of a commercially available wire mesh overlay is shown in FIG. 1. Alternatively, a wedgewire strainer element ranging from 0.075″ to 0.002″ opening may be used. An example of a commercially available wedgewire strainer is shown in FIG. 2. A perforated strainer element with filter socks ranging from 0.020″ to 0.0016″ opening may also be used. An example of a commercially available perforated strainer is shown in FIG. 3, and a strainer element with filter sock shown in FIG. 4.

Sanitary Design Standards

All food, beverage and pharmaceutical processing companies are required to have hygienic processes when producing products that must meet the FDA and other regulatory requirements. For example, the FDA Food Safety Modernization Act defines rules/laws related to food safety for all FDA regulated manufacturers, which includes a risk assessment to eliminate or mitigate the risk of physical hazards. The industries have also evolved to create their own sanitary design standards associations that focus on proven best practices to create processing equipment designs that are cleanable. The two main sanitary design standard groups are 3A for the food and beverage industries and ASME BPE for the pharmaceutical industry. 3A oversees the 3-A Symbol Authorization program and other voluntary certificates to help affirm the integrity of hygienic processing equipment and systems. To obtain symbol use on a product, the product must adhere to 3A design standards along with having an official 3A auditor review all design and manufacturing practices. If a product does not meet the 3A cleanability standard it does not mean that the product cannot be used when processing. Instead, it means that a specific cleaning process will need to be used for the product.

In the noted industries, there are two types of cleaning: the first of which is COP (Clean Out of Place); and the second of which is CIP (Clean In Place). When a strainer that meets the requirements of the industry hygienic or sanitary equipment standards, it implies that if you use the product as designed by the Original Equipment Manufacturer (OEM), the product can be CIP. It is advantageous to the end users to CIP all process equipment for several reasons. If a product is classified as COP, that means the product must be disassembled from the production line and manually handled and cleaned which adds cost to handle the product and risk of damaging the product along with the risk of manual cleaning which allows human error and could lead to a product recall or product scrap.

When applying the industry hygienic design standards to the types of sanitary strainers listed previously, only the course straining perforated element is considered to meet industry hygienic design standards, which means it could be CIP. In comparison, the wedgewire and mesh overlays are not considered sanitary due to cracks and crevices that are created/required during the manufacturing process and must be COP. The filter socks are disposable.

While disc strainer technology is known, the disc strainer technology on the market today is not used in the sanitary processing market for a couple of reasons: the temperature rating only goes to 160 degrees F. which is not high enough for the industry requirements and the plastic; and molded, physical designs are not considered sanitary.

Consequently, there is currently no CIP industry hygienic design standards finer strainer in existence today. Therefore, a need exists for a CIP industry hygienic design standards strainer which reduces down time and costs for food, beverage, cosmetics and pharmaceutical industries.

### SUMMARY

Accordingly, a sanitary (or hygienic) disc strainer which reduces down time and costs for food, beverage, cosmetics and pharmaceutical industries is provided.

Disclosed is a sanitary disc strainer that meets the industry requirements to allow food, beverage and pharmaceutical manufacturers to CIP finer strainers. The product uses disc stacking technology. More specifically, the strainer element is made up of a stack of thin, grooved disc which are compressed into a cylinder to create a strainer element. Advantageously, the angle of the grooves in the discs results in cross hatching when the discs are stacked. Stacking and compression of the discs creates pores and tortuous path flow. The disc stack also provides three-dimensional depth filtration. The disc stack is compressible/decompressible, allowing the discs to be cleaned in place by direction and control of fluid flow between the discs.

A sanitary disc strainer is described herein. The sanitary disc strainer includes a strainer body, a moveable guide rod assembly, moveable within the strainer body, a plurality of grooved discs stacked on the moveable guide rod assembly, and an actuator for moving the moveable guide rod assembly to compress and decompress the plurality of grooved discs. The sanitary disc strainer can be cleaned-in-place or removed and cleaned manually out of place.

A method of removing debris from a process fluid is also described. The method includes compressing, via an actuator, a plurality of grooved discs within a strainer body, pumping a process fluid through an inlet of the strainer body, directing the process fluid through a tortuous pathway formed by the plurality of compressed grooved discs, such that the debris can not pass through the tortuous pathway, and removing the process fluid from the strainer body via an outlet.

A filter disc assembly is described. The filter disc assembly includes a strainer body or housing, a moveable guide rod assembly, moveable within the strainer body, a plurality of grooved discs stacked on the moveable guide rod assembly, and a manual piston joined to the moveable guide rod assembly to compress the plurality of grooved discs within the strainer body. The plurality of grooved discs and movable guide rod assembly can be disassembled and removed from the strainer body to be cleaned out of place.

### BRIEF DESCRIPTION OF DRAWINGS

Various examples of embodiments of the systems, devices, and methods according to this invention will be described in detail, with reference to the following figures.

FIG. 1 illustrates an example of an existing wire mesh overlay strainer element.

FIG. 2 illustrates an example of an existing wedgewire strainer element.

FIG. 3 illustrates an example of an existing perforated strainer element.

FIG. 4 illustrates an example of an existing perforated strainer element of FIG. 3, with a filter sock.

FIG. 5 depicts an example of a sanitary disc strainer described herein.

FIG. 6 is a cross-sectional view of the example sanitary disc strainer of FIG. 5.

FIG. 7 is a cross-sectional view of an alternative example sanitary disc strainer similar to that of FIG. 5.

FIG. 8 is a partial exploded view of the example sanitary disc strainer of FIG. 7.

FIG. 9 is an exploded view of the example sanitary disc strainer of FIG. 6.

FIG. 10 depicts a more detailed view of the example discs of the example sanitary disc strainers of FIGS. 5-9.

FIG. 11 depicts a more detailed view of the grooved surfaces of the example discs of FIG. 10, showing the filtering capability of such discs.

FIG. 12 is a more detailed view of an end of the body of the example sanitary disc strainers of FIGS. 5-9 and the example discs within the example sanitary disc strainer.

FIG. 13A depicts an example cross-section of the example sanitary disc strainer described herein, showing example flow paths of an example processing fluid while in a straining position.

FIG. 13B depicts a more detailed view of a portion of the discs in the cross-section of FIG. 13A.

FIG. 14A depicts an example cross-section of the example sanitary disc strainer described herein, showing example flow paths of an example processing fluid while in a cleaning-in-place position.

FIG. 14B depicts a more detailed view of a portion of the discs in the cross-section of FIG. 14A.

FIG. 15 depicts an example system within which the example sanitary disc strainer described herein may be used while in a straining position.

FIG. 16 depicts an example system within which the example sanitary disc strainer described herein may be used while in a cleaning-in-place position.

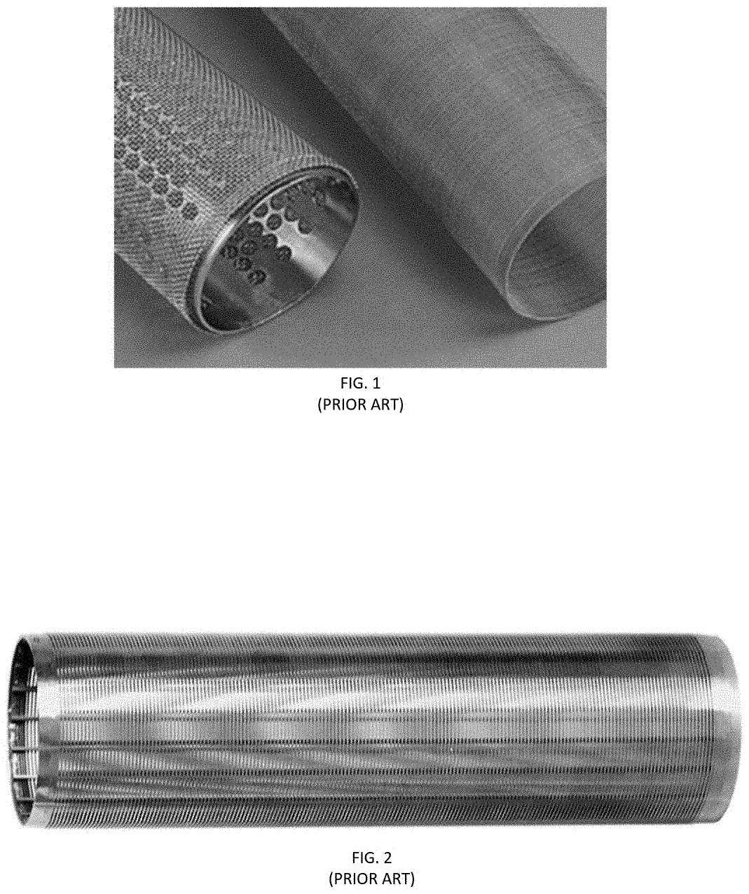

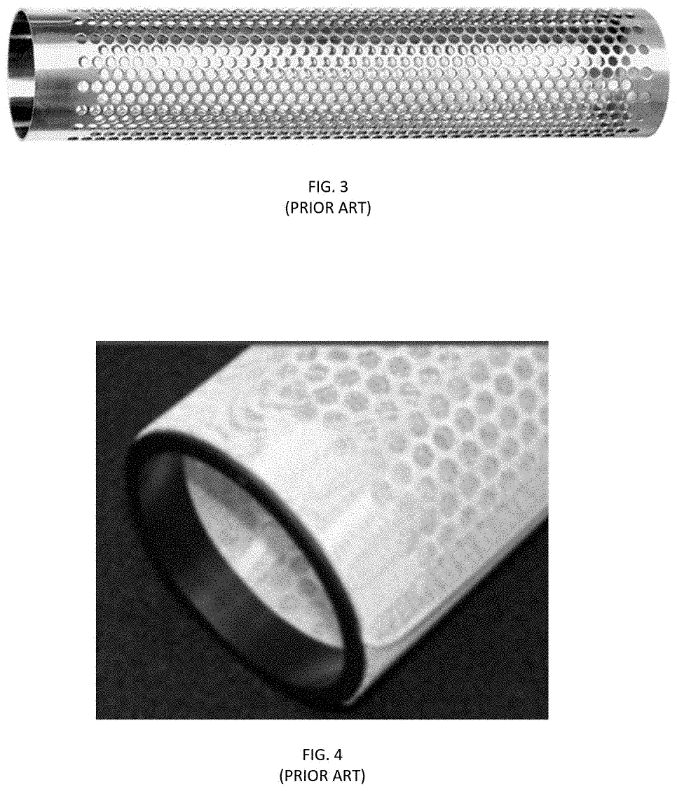

It should be understood that the drawings are not necessarily to scale. In certain instances, details that are not necessary to the understanding of the invention or render other details difficult to perceive may have been omitted. It should be understood, of course, that the invention is not necessarily limited to the particular embodiments illustrated herein.

### DETAILED DESCRIPTION

One or more specific embodiments will be described below. In an effort to provide a concise description of these embodiments, not all features of an actual implementation are described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

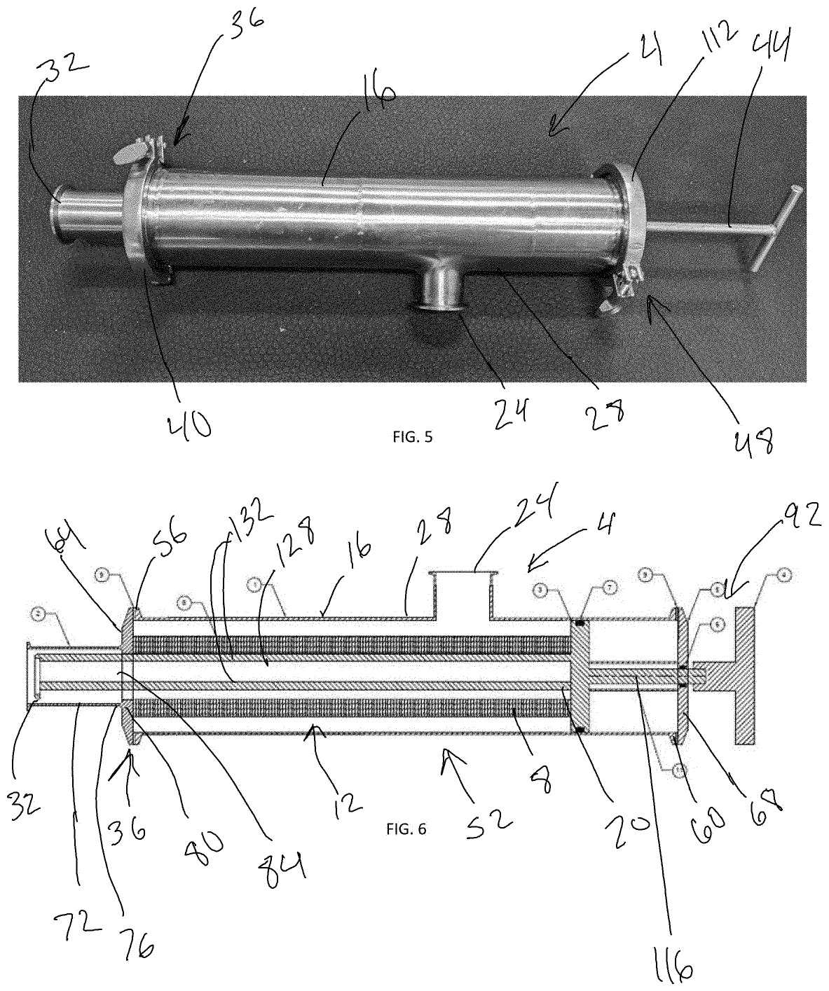

Referring to the Figures, a sanitary disc strainer 4 and method of use of a sanitary disc strainer 4 are disclosed. The sanitary disc strainer 4 uses disc 8 stacking technology. More specifically, a strainer element 12 is made up of a stack of thin, grooved discs 8 which are compressed into a cylinder to create the strainer element 12. Referring to FIGS. 5-12, the sanitary disc strainer 4 may be generally composed of a strainer body 16 or housing, a moveable guide rod assembly 20, a plurality of the grooved discs 8, and a means for moving the moveable guide rod assembly (e.g., an actuator, a handle).

Specifically, FIG. 5 depicts an example of the sanitary disc strainer 4. The example sanitary disc strainer 4 includes an inlet 24 coupled on a side 28 of the strainer body 16 and an outlet 32 at a first end 36 of the strainer body 16. The first end 36 of the strainer body 16 may be attached to the strainer body 16 using, for example, a ring clamp 40. The example sanitary disc strainer 4 of FIG. 5 includes a handle 44 to move or adjust the movable guide rod assembly 20. The handle 44 is attached to a second end 48 of the strainer body 16. Alternatively, another method of attaching the end 36 to the strainer body 16 may be used.

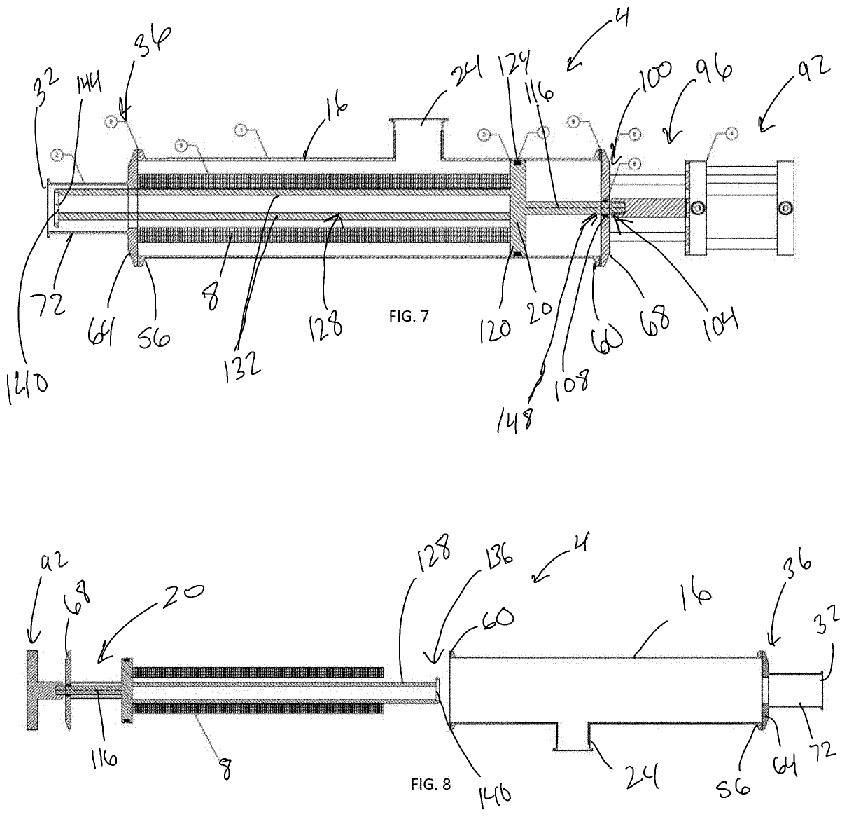

FIG. 6 is a cross-sectional view of the example sanitary disc strainer 4 of FIG. 5. FIG. 7 is a cross-sectional view of an alternative example sanitary disc strainer similar to that of FIG. 5. FIG. 8 is a partial exploded view of the example sanitary disc strainer of FIG. 7. FIG. 9 is an exploded view of the example sanitary disc strainer of FIG. 6. While FIGS. 6-9 may depict different embodiments of the example sanitary disc strainer 4, the different constructions of the sanitary disc strainer 4 illustrated are similar and like features are labeled accordingly. Specifically, one difference between the construction of FIGS. 5, 6, 8 and the construction of FIGS. 7 and 9 is the means for moving the movable guide rod assembly.

As shown in FIG. 6, The strainer body 16 is generally a cylindrical hollow tube 52 or pipe extending between the first end 36 and the second end 48. Each end 36, 48 of the strainer body 16 may have a flange 56, 60 or flared portion for attachment to a mating component such as a cap or end cap 64, 68. The exit end (e.g., first end 36) of the body 16 has a body outlet cap 64 which includes a narrowed cylinder 72 having an attachment end 76 configured for attachment to the first end 36 of the strainer body 16. The narrowed cylinder 72 has an inner diameter which is smaller than the diameter of the body 16. The attachment end 76 of the body outlet cap 64 has an outer diameter which is the same diameter as the outlet 32 of the strainer body 16 and may include a flange 80 thereon for mating with the first end 36 of the body 16. The attachment end 76 of the body outlet cap 64 has an aperture 84 or orifice which is smaller than the inner diameter of the body 16, and in some examples of embodiments may be smaller in diameter than the inner diameter of the body outlet 32. A gasket 88 is provided between the first end of 36 the body 16 and the body outlet cap 64 to assist in sealing the removable coupling of the two components (see FIG. 9), and the two components are secured by a removable clamp mechanism (e.g., the ring clamp 40) which couples to or over the respective flanges 56, 60.

As shown in FIGS. 6-9, a cap 68 is provided on the actuator end (e.g., second end 48) of the body 16. The cap 68 may include an actuator 92 or air cylinder mount assembly. The actuator 92 includes a frame member (e.g., mount assembly) 96 which has a body coupling end 100 forming the cap 68 that is configured to be joined to the second end 48 of the body 16. The body coupling end 100 of the mount assembly 96 has a diameter which corresponds to the second end 48 of the body 16 and may include a flange 60. An aperture 104 is provided in the body coupling end 100 for receipt of a portion of the moveable guide rod assembly 20 or piston. A gasket 108 may be provided between the body coupling end 100 of the mount assembly 96 for the actuator 92 and the body 16. A removable clamp 112 may be secured to or over the respective flanges 60 of the body 16 and/or body coupling end 100 of the mount assembly 96 or cap 68.

As indicated, a moveable guide rod assembly 20 may be coupled to an actuator or air cylinder (e.g., a pneumatic actuator) 92 or piston and is moveable longitudinally within the strainer body 16 for carrying, compressing, and decompressing the plurality of grooved discs 8. In one or more examples of embodiments, the guide rod assembly 20 is a piston guide rod assembly. The moveable guide rod assembly 20 has a guide rod 116 which extends through the aperture 104 in the body coupling end 100 and is coupled to the air cylinder or actuator 92. The guide rod 116 has a guide rod weldment 120 attached thereto. The guide rod weldment 120 has a diameter which corresponds to the inner diameter of the body 16. The piston guide rod weldment 120 may have an O-ring 124 or other resilient sealing mechanism for engaging the body 16. The mount assembly for the actuator 92 and/or cap 68 may also have an O-ring or other resilient sealing mechanism for engaging the guide rod 116 that extends therethrough. The actuator 92 enables the clean-in-place process of the sanitary disc strainer 4 to be fully automated.

The guide rod weldment 120 is joined to a carrier 128 having the plurality of grooved discs 8 thereon. The carrier 128 may be a spine assembly that comprises a longitudinal rod or plurality of longitudinal rods 132. In the illustrated embodiment, a plurality, namely two longitudinal rods 132 are spaced apart and extend in parallel from the guide rod weldment 120. In other examples, a different number of longitudinal rods 132 (such as three rods) may be used. Alternatively, the carrier may be a cylindrical tube or rod that may have a different cross-sectional shape. The spacing between the rods 132 is sufficient to support the plurality of grooved discs 8, but also allow movement of the discs 8 thereon. An end 136 of the carrier 128 opposite the piston guide rod weldment 120 has a disc retainer washer 140 thereon which may operate as both a disc retainer and a stop that abuts the aperture 84 or orifice adjacent the first end 36 of the body 16. The disc retainer washer 140 has an orifice 144 which is of a different diameter than the aperture 84 or orifice of the cap 64 on the first end 36. In particular, the orifice 144 of the disc retainer washer 140 is smaller.

In the sanitary disc strainer 4 shown in FIGS. 5, 6, and 8, a handle 44 or tee-handle, and cap is used in place of the actuator 92 and mount assembly 96. That is, the cap 68 is coupled to the second end 48 of the body 16 and may be secured by a clamp 40 as previously described. The cap 68 has an aperture 148 for passage of the guide rod 116 or piston guide rod. An O-ring 124138 may be provided in the aperture 148 to seal the connection between the guide rod 116 and cap 68. In the illustrated embodiment, a spacer or spring may also be provided between the cap and the guide rod weldment 120. The handle 44 or tee-handle is attached to the piston guide rod 116. The handle 44 may be grasped by a user and manually moved (e.g., pulled or pushed) to move the assembly 20 and compress or decompress the plurality of discs 8 as previously described.

As indicated and shown in FIGS. 6-12, a plurality of grooved discs 8 are carried by the disc carrier 128 within the body 16. While grooved discs 8 are described, the disc size and pattern may vary to provide different openings and allow different flow rates. In one or more preferred examples of embodiments, grooved discs 8 are selected which achieve small filtration sufficient to make the sanitary disc strainer 4 CIP'able, that is, cable of being Cleaned In Place. While the discs 8 are described herein as being CIP, one of skill in the art will appreciate that the discs may alternatively be manually disassembled for cleaning.

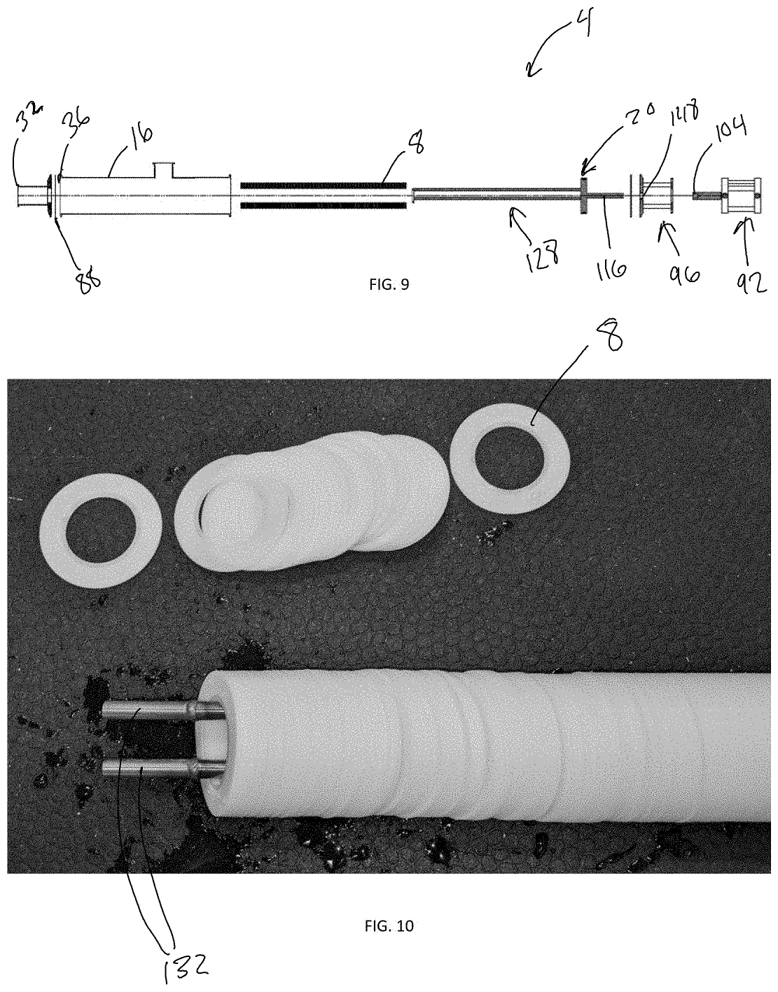

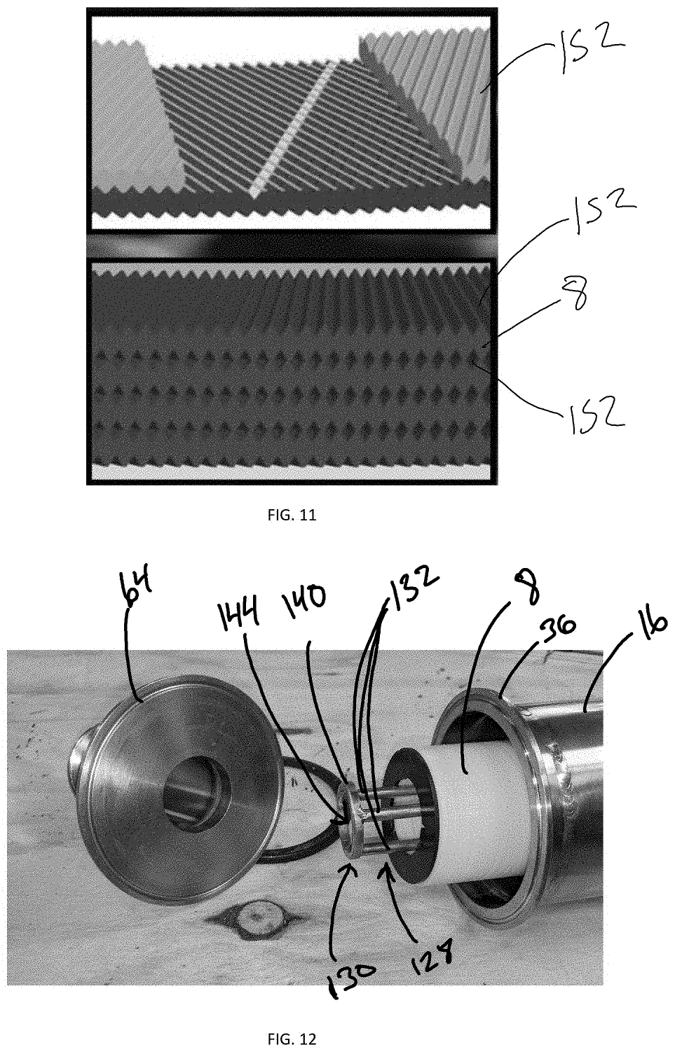

FIG. 10 depicts a more detailed view of the example discs 8 on the carrier 128 of the example sanitary disc strainers 4. FIG. 11 depicts an example detailed view of the grooves 152 of the discs 8. FIG. 12 is a more detailed view of the first end 36 of the body 16 of the example sanitary disc strainers 4 of FIGS. 5-9 and the example discs 8 within the example sanitary disc strainer 4.

The angle of the grooves 152 in the discs 8 results in cross hatching when the discs 8 are stacked. Stacking and compression of the discs 8 creates pores or openings formed by a tortuous pathway through which a process fluid flows. The disc stack also provides three-dimensional depth filtration. According to one or more examples of embodiments, the grooved discs 8 are stacked onto the piston guide rod assembly 20, namely the disc carrier 128. The discs 8 are allowed to “float” in this position on the disc carrier 128. As previously described, the plurality of grooved discs 8 comprise a stack of thin, grooved discs 8 which when compressed into a cylinder create the strainer element 12. The angle of the grooves 152 in the discs 8 results in cross hatching when the discs 8 are stacked. When the discs 8 are decompressed, the spacing between grooves 152 increases and they are allowed to float or move around, thereby permitting cleaning in the grooves 152 and between the discs 8. The example grooves 152 may be sized based on the application for which the sanitary disc strainer 4 is being used. That is, the grooves 152 may be more shallow (i.e., openings formed by the spacings between the grooves (when compressed) will be smaller) when the disc strainer 4 is being used with a process fluid that needs very fine straining, and the grooves may be deeper (i.e., the openings may be larger) when the disc strainer 4 is being used with a process fluid that doesn't need very fine straining. For example, the size of the openings may range between five thousandths of an inch to thirty thousandths of an inch. The openings may, in some examples, be as large as sixty thousandths of an inch.

In one or more of the illustrated embodiments, a means to compress and decompress the discs is provided. In the illustrated examples of FIGS. 6 and 9, the actuator 92 or air cylinder is attached to the sanitary strainer 4, and in particular to the guide rod assembly 20 for moving the guide rod assembly 20 within the body 16 of the sanitary strainer 4. Alternatively, the handle 44 or a piston may be attached to the sanitary strainer 4 as shown in certain examples of embodiments. In this regard, a means to compress and decompress the discs 8 is provided attached to the guide rod assembly 20. Note, while a handle is shown in the drawings (FIGS. 5, 7, and 8), a spring may be used for compression/decompression of the discs 8. While various examples are provided, any suitable mechanism for compressing and decompressing the discs 8 may be used. Likewise, as will be described hereinbelow, compression of the discs 8 may be by automated or manual means.

The strainer body 16 or housing described herein may be composed of high purity stainless steel, TIG welded to ASME food grade standards. The moveable guide rod assembly 20 may be composed of high purity stainless steel, TIG welded to ASME food grade standards. The grooved discs 8 may be plastic injection molded discs composed of FDA compliant plastic. The actuator may be an automated or manual piston actuator, which includes a mounting mechanism, and may be compose of a high purity stainless steel, air cylinder.

To assemble the sanitary strainer 4, the plurality of discs 8 is placed on the longitudinal rods 132 of the guide rod assembly 20. The assembly 20 is then inserted into the strainer body 16 from the first end 36 of the strainer body 16. The guide rod 116 is guided through the aperture of the cap 68 on the second end 48. The cap 64 is then attached to the first end 36 of the body 16. The movable guide rod assembly 20 is then moved to compress the discs 8. The piston guide rod assembly 20 is then clamped in place with either a spring mechanism along with a manual locking device to hold provide pressure to the disc stack, or with a spring to close air actuator providing the force on the stack.

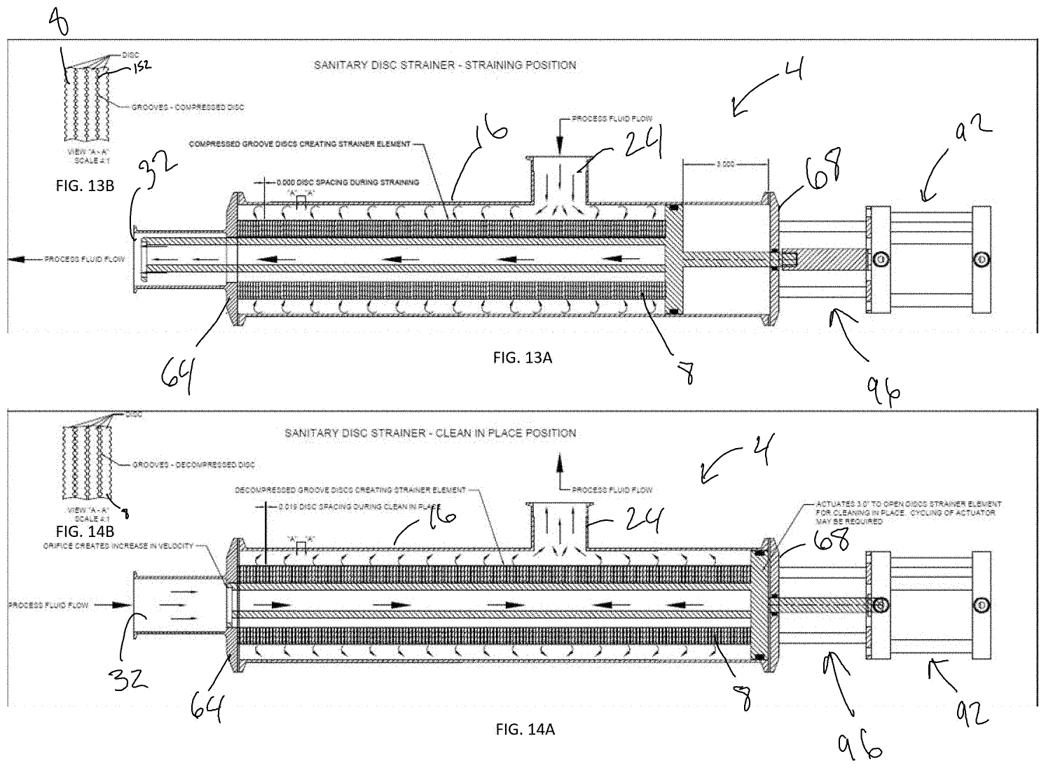

An example of operation of a sanitary disc strainer is shown in FIGS. 13A-16.

Filtration Mode

FIG. 13A depicts an example cross-section of the example sanitary disc strainer described herein, showing example flow paths of an example processing fluid while in a straining position. The strainer element 12 is compressed during filtration mode by movement of the piston/guide rod assembly 20 toward the first end 36, thereby compressing the discs 8. The strainer element 12 in this orientation retains debris and contaminants from continuing in the flow stream which enters through the inlet 24 and exits the body outlet 32. FIG. 13B depicts a more detailed view of a portion of the compressed discs 8.

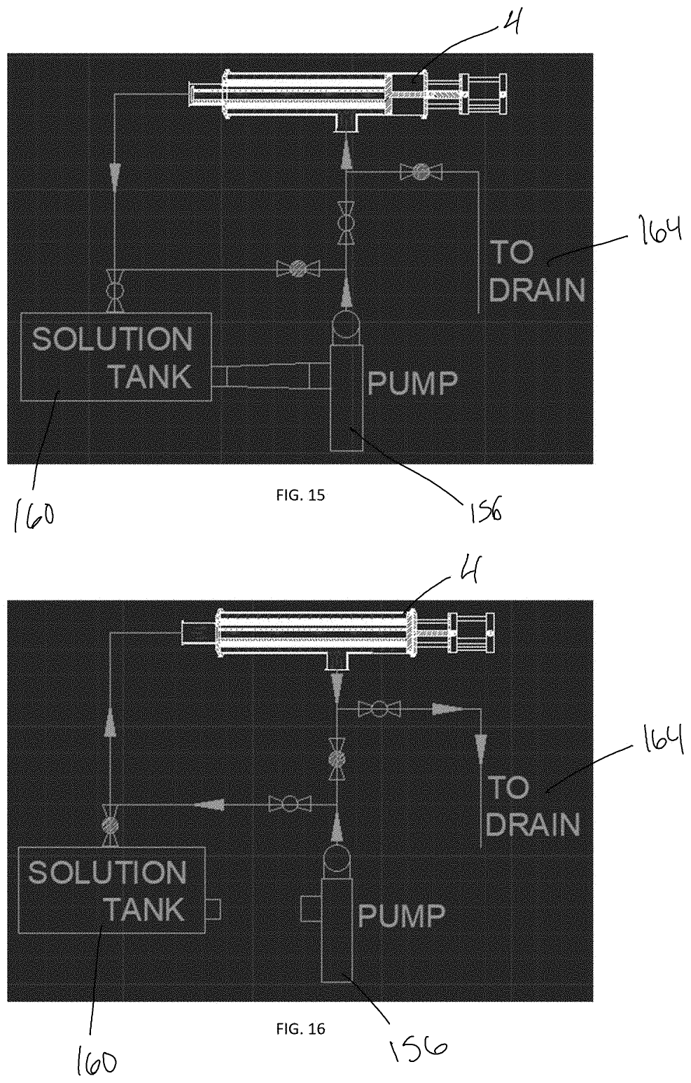

FIG. 15 depicts an example system within which the example sanitary disc strainer 4 described herein may be used while in a straining position. In the example system, a pump 156 pumps the processing fluid into the inlet 24. The process fluid flows through the strainer element 12, filtering out debris and contaminants, to a solution tank 160. In filtration mode (e.g., normal operating mode), valves between the pump 156 and the sanitary disc strainer 4 and between the sanitary disc strainer 4 and the solution tank 160 are open, and valves between the pump 156 and the solution tank 160 and between the sanitary disc strainer 4 and the drain 164 are closed.

Cleaning Mode

To clean the strainer element 12, and in particular to Clean In Place (CIP) the strainer element 12 fluid flow is reversed. FIG. 14A depicts an example cross-section of the example sanitary disc strainer 4 described herein, showing example flow paths of an example processing fluid while in the CIP position. When the flow is reversed to cleaning mode, the outlet 32 becomes the inlet 24. In this regard, fluid flows in the outlet 32 and out the inlet 24. More specifically, the flow is reversed to flush the debris to a drain 164 and then the disc stack is decompressed (e.g., in a cleaning position) allow any trapped debris to flow out of the strainer 4 to drain 164, as depicted in FIG. 16. That is, fluid flow is reversed before the stack of discs is decompressed. FIG. 14B depicts a more detailed view of a portion of the uncompressed discs 8. The cleaning operation may be used on a regular schedule (e.g., daily) and may also be used as needed when the disc strainer 4 is clogged (e.g., a pressure reduces, a flow rate reduces). In some examples, the cleaning operation may be repeated to ensure the disc strainer 4 is completely cleaned. In cleaning mode (e.g., normal operating mode), valves between the pump 156 and the sanitary disc strainer 4 and between the sanitary disc strainer 4 and the solution tank 160 are closed, and valves between the pump 156 and the solution tank 160 and between the sanitary disc strainer 4 and the drain 164 are open.

Uniquely, the body outlet cap 64 has a smaller inside diameter than the incoming flow tube and therefore acts as an orifice plate and increases the velocity of the fluid going into the body 16 or housing. Additionally, the orifice plate may enable specific directional flow to enhance cleanability. When the piston guide rod weldment 120 is moved or actuated, allowing the discs 8 to decompress, the disc retainer washer 140 on the guide rod assembly 20 moves into the body outlet cap 64 inside diameter and decreases the opening for flow and again acts as an orifice plate which increases the velocity further. In other words, this action changes the velocity of the flow, which creates a higher flow velocity and helps clean in place, while adding a venturi effect. The action of increasing the velocity along with the discs 8 being separated and allowing the discs 8 to float or move about make the strainer cleanable, and in particular CIP.

While a CIP method is described, one of skill in the art will appreciate that, alternatively, the sanitary disc strainer 4 can be disassembled for Cleaning Out of Place (COP). For instance, in one example of embodiments, the guide rod assembly 20, weldment 120, carrier 138, plurality of grooved discs 8, and manual or actuation mechanism connected thereto may be removed from the body 16 and cleaned out of place. In this regard, the discs 8 are allowed to “float” or move about on the carrier 138 which provides an improved ability to remove debris from the discs 8 and carrier 138. In one or more further examples of embodiments, the entire sanitary disc strainer 4 may be disassembled and individual components may be cleaned.

### EXAMPLES

The following Examples are an illustration of one or more examples of embodiments and are not intended as to limit the scope of the disclosure. As will be seen from the following Examples, testing has shown results of 100% effective cleaning cycling the following test protocol.

### Example 1

In one or more examples of embodiments, a sample product was tested to determine the effectiveness of the sanitary disc strainer 4. In the example test, a sanitary disc strainer 4 as described herein and shown in the Figures was provided for testing. A flow rate of 50 gpm and a media of quinoa, 3 ounces, was used.

Step 1: Flow rate was established and quinoa media was added to the sanitary disc strainer in a compressed state for filtration flow.

Results: In this position, it was verified that the filter captured 100% of the quinoa by filtering the discharge flow with a nylon.

Step 2: The flow rate was then reversed while the sanitary disc strainer 4 remained in a compressed state.

Results: The results demonstrated that 95% plus of quinoa media was recovered in the discharge flow.

Step 3: With the flow rate reversed, the sanitary disc strainer 4 was then moved to a decompressed state.

Results: Results demonstrated that almost all remaining quinoa media was captured.

Step 4: Steps 1, 2, and 3 were repeated.

Results: Results demonstrated that the strainer element was 100% clean, no debris.

### Example 2

In one or more examples of embodiments, an additional sample product was tested to determine the effectiveness of the sanitary disc strainer. In the example test, a sanitary disc strainer as described herein and shown in the Figures was provided for testing. A flow rate of 23 gpm and a media of chocolate syrup was used. In this example, the entire housing of the sanitary disc strainer was covered with chocolate syrup to verify there were no air pockets during testing.

The same steps 1-4 as provided in Example 1 were repeated. The results demonstrated that no trace of chocolate syrup media was present, verifying that the housing will clean at 23 gpm.

Accordingly, a sanitary (or hygienic) disc strainer 4 which reduces down time and costs for food, beverage, cosmetics and pharmaceutical industries is provided. The CIP sanitary disc strainer 4 described herein provides various advantages over existing devices. The sanitary disc strainer 4 provides an automated, consistent method to cleaning strainers which does not exist today. For example, the sanitary disc strainer 4 is a finer strainer capable of CIP. The sanitary disc strainer 4 described herein therefore provides increased food safety. In addition, the sanitary disc strainer 4 eliminates or significantly reduces damage caused by handling strainer insert elements. The sanitary disc strainer 4 also allows for increased available production time by not having to remove the strainer element 12 for cleaning.

While various examples of a CIP sanitary disc strainer 4 are provided, one or more alternative examples of embodiments of a sanitary disc strainer 4 may comprise manual operating/cleaning of the strainer 4. For example, the current state of finer strainer elements on the market today are typically Clean Out of Place (COP) hand cleaned or placed in an immersion washer, including, for example a hot bath with chemical and water jets providing agitation. The wedgewire and wire mesh overlays of existing strainers are removed from the housing and typically have to be hand brushed cleaned as the small openings make it difficult to clean in just an immersion washer. Food particles become stuck or wedged in the small openings and usually require a brush or high pressure spray for removal. The disc strainer 4 design described herein allows the discs 8 to float/separate which increases the opening size and allows the debris to be cleared from the element with ease. Additionally, the entire assembly can be disassembled to be cleaned and inspected. In comparison, a user cannot disassemble the wedgewire or wire mesh to inspect all the cracks and crevices especially on the inside diameter.

As utilized herein, the terms “approximately,” “about,” “substantially”, and similar terms are intended to have a broad meaning in harmony with the common and accepted usage by those of ordinary skill in the art to which the subject matter of this disclosure pertains. It should be understood by those of skill in the art who review this disclosure that these terms are intended to allow a description of certain features described and claimed without restricting the scope of these features to the precise numerical ranges provided. Accordingly, these terms should be interpreted as indicating that insubstantial or inconsequential modifications or alterations of the subject matter described and claimed are considered to be within the scope of the invention as recited in the appended claims.

It should be noted that references to relative positions (e.g., “top” and “bottom”) in this description are merely used to identify various elements as are oriented in the Figures. It should be recognized that the orientation of particular components may vary greatly depending on the application in which they are used.

For the purpose of this disclosure, the term “coupled” means the joining of two members directly or indirectly to one another. Such joining may be stationary in nature or moveable in nature. Such joining may be achieved with the two members or the two members and any additional intermediate members being integrally formed as a single unitary body with one another or with the two members or the two members and any additional intermediate members being attached to one another. Such joining may be permanent in nature or may be removable or releasable in nature.

It is also important to note that the construction and arrangement of the system, methods, and devices as shown in the various examples of embodiments is illustrative only. Although only a few embodiments have been described in detail in this disclosure, those skilled in the art who review this disclosure will readily appreciate that many modifications are possible (e.g., variations in sizes, dimensions, structures, shapes and proportions of the various elements, values of parameters, mounting arrangements, use of materials, colors, orientations, etc.) without materially departing from the novel teachings and advantages of the subject matter recited. For example, elements shown as integrally formed may be constructed of multiple parts or elements show as multiple parts may be integrally formed, the operation of the interfaces may be reversed or otherwise varied, the length or width of the structures and/or members or connector or other elements of the system may be varied, the nature or number of adjustment positions provided between the elements may be varied (e.g. by variations in the number of engagement slots or size of the engagement slots or type of engagement). The order or sequence of any process or method steps may be varied or re-sequenced according to alternative embodiments. Other substitutions, modifications, changes and omissions may be made in the design, operating conditions and arrangement of the various examples of embodiments without departing from the spirit or scope of the present inventions.

While this invention has been described in conjunction with the examples of embodiments outlined above, various alternatives, modifications, variations, improvements and/or substantial equivalents, whether known or that are or may be presently foreseen, may become apparent to those having at least ordinary skill in the art. Accordingly, the examples of embodiments of the invention, as set forth above, are intended to be illustrative, not limiting. Various changes may be made without departing from the spirit or scope of the invention. Therefore, the invention is intended to embrace all known or earlier developed alternatives, modifications, variations, improvements and/or substantial equivalents.

The technical effects and technical problems in the specification are exemplary and are not limiting. It should be noted that the embodiments described in the specification may have other technical effects and can solve other technical problems.

What is claimed is:

1. A sanitary disc strainer comprising:
a strainer body;
a moveable guide rod assembly, moveable within the strainer body;
a plurality of grooved discs stacked on the moveable guide rod assembly; and
an actuator for moving the moveable guide rod assembly to compress and decompress the plurality of grooved discs.

2. The sanitary disc strainer of claim 1, wherein grooves of the plurality of grooved discs form a tortuous pathway when the plurality of grooved discs is compressed.

3. The sanitary disc strainer of claim 2, wherein a diameter of openings of the tortuous pathway is between five thousandths of an inch and sixty thousandths of an inch.

4. The sanitary disc strainer of claim 3, wherein the diameter is between five thousandths of an inch and thirty thousandths of an inch.

5. The sanitary disc strainer of claim 1, wherein the actuator is a manual actuator.

6. The sanitary disc strainer of claim 1, wherein the actuator is a pneumatic actuator.

7. The sanitary disc strainer of claim 1, further including an inlet on the strainer body.

8. The sanitary disc strainer of claim 1, further including an outlet on an end of the strainer body.

9. The sanitary disc strainer of claim 8, further comprising a first end cap on the end of the strainer body, the outlet passing through the first end cap.

10. The sanitary disc strainer of claim 9, further comprising a second end cap on a second end of the strainer body, the actuator passing through the second end cap.

11. The sanitary disc strainer of claim 10, wherein, during a cleaning operation, a first end cap acts as an orifice plate which increases fluid velocity of a process fluid and creates a venturi effect in the strainer body.

12. A method of use of the sanitary disc strainer of claim 1, comprising the steps of:
moving the moveable guide rod assembly into a straining position wherein the plurality of grooved discs are compressed, forming a compressed disc stack;
providing fluid flow from an inlet through the compressed disc stack to an outlet;
reversing the fluid flow to flow from the outlet to the inlet through the compressed disc stack; and
moving the moveable guide rod assembly into a cleaning position wherein the plurality of grooved discs are decompressed and continuing the fluid flow from the outlet to the inlet.

13. The method of claim 12, further comprising engaging a removably engageable orifice plate in the outlet when in the cleaning position to increase fluid velocity.

14. A system in which the sanitary disc strainer of claim 1 is used, wherein the system includes:
a pump to pump a process fluid through the sanitary disc strainer;
a solution tank to store the process fluid that has passed through the sanitary disc strainer; and
a drain to remove debris during a cleaning operation of the sanitary disc strainer.

15. The system of claim 14, further including a plurality of valves to open and close based on whether the system is in the cleaning operation.

16. A method of removing debris from a process fluid, the method comprising:
compressing, via an actuator, a plurality of grooved discs within a strainer body;
pumping a process fluid through an inlet of the strainer body;
directing the process fluid through a tortuous pathway formed by the plurality of compressed grooved discs, such that the debris cannot pass through the tortuous pathway; and
removing the process fluid from the strainer body via an outlet.

17. The method of claim 16, further comprising cleaning the strainer body and grooved discs by:
reversing a flow of the process fluid such that the fluid flows into the outlet and out of the inlet; and
decompressing the plurality of grooved discs using the actuator while the process fluid is flowing in reverse.

18. A filter disc assembly comprising:
a strainer body or housing;
a moveable guide rod assembly, moveable within the strainer body;
a plurality of grooved discs stacked on the moveable guide rod assembly; and
a manual piston joined to the moveable guide rod assembly to compress the plurality of grooved discs within the strainer body;
wherein the plurality of grooved discs and movable guide rod assembly can be disassembled and removed from the strainer body to be cleaned out of place.

19. The filter disc assembly of claim 18, wherein grooves of the plurality of grooved discs form a tortuous pathway when the plurality of grooved discs is compressed.

20. The filter disc assembly of claim 19, wherein a diameter of openings of the tortuous pathway is between five thousandths of an inch and sixty thousandths of an inch.
